(19) United States
(12) Patent Application Publication
(10) Pub. No.: US 2020/0374435 A1
(43) Pub. Date: Nov. 26, 2020

(54) DIGITAL CAMERA AND DOMESTIC REFRIGERATOR COMPRISING A DIGITAL CAMERA

(71) Applicant: BSH HAUSGERAETE GMBH, MUENCHEN (DE)

(72) Inventors: JOCHEN GRIMMINGER, DILLINGEN (DE); CHRISTOPHER RODNEY, BURGAU (DE); HANS PETER WERNER, GIENGEN (DE); DANIEL BIHR, KIRCHHEIM AM RIES (DE)

(21) Appl. No.: 16/636,926

(22) PCT Filed: Sep. 11, 2018
(86) PCT No.: PCT/EP2018/074431

§ 371 Date: Feb. 6, 2020

(30) Foreign Application Priority Data
Sep. 25, 2017 (DE) 10 2017 216 959.1

(51) Int. Cl. H04N 5/225; H04N 5/232

(52) U.S. Cl. CPC H04N 5/2258; F25D 2400/36; H04N 5/2253; H04N 5/232

(57) ABSTRACT

A domestic refrigerator has a digital camera. The digital camera includes at least two optical devices, each of which has an image sensor and a lens arranged upstream of the image sensor. A common electronic controller is configured to actuate the at least two optical devices and read the image sensors in order to generate an image data set on the basis of the read image sensors.

The invention relates to a digital camera, a household refrigeration appliance comprising a digital camera.

DE 10 2013 211 099 A1 discloses a household refrigeration appliance which comprises a refrigeration compartment and a camera module. The camera module comprises a perforated panel and a circuit board on which a chip with a light sensor field for capturing image data of refrigerated goods stored in the refrigeration compartment and a microcontroller for processing the image data are arranged.

The object of the present invention is to specify an improved digital camera and an improved household refrigeration appliance comprising a digital camera.

The object of the invention is achieved by means of a digital camera having at least two optical devices, each of which comprises an image sensor and a lens arranged upstream of the image sensor, and a common electronic controller which is designed to actuate the at least two optical devices and to read the image sensors in order to generate at least one image data set on the basis of the read image sensors, or by means of a household refrigeration appliance, having a heat-insulated carcass with an inner container, which delimits a coolable interior space provided for storing food, a refrigeration device for cooling the coolable interior space and the inventive digital camera which is attached in or to the household refrigeration appliance.

Further aspects of the invention relate to a method for operating the inventive digital camera and a method for operating the inventive household refrigeration appliance, comprising the following method steps:
Actuating at least one of the optical devices by means of the common electronic controller,
reading the corresponding image sensor(s) by means of the common electronic controller, and
by means of the common electronic controller, generating at least one image data set on the basis of the read image sensor(s).

The inventive digital camera accordingly comprises a plurality of optical devices and the common electronic controller. The optical devices, each of which comprises an image sensor and a lens arranged upstream of the image sensor, are actuated by this common electronic controller. The common electronic controller is also set up to read the image sensors in order to generate one or more image data sets from the signals read from the image sensors.

In this way it is possible for example to arrange a plurality of optical devices in the or on the inventive household refrigeration appliance in order to generate for example different images or image data sets assigned to these images, and at the same time to reduce the outlay in terms of electronics as one common electronic controller is used.

The image data set generated by the common electronic controller is for example assigned to an image which was captured by precisely one of the optical devices. In particular in this context it can be provided that the common electronic controller optionally actuates one of the optical devices and reads the image sensor assigned to this optical device in order to obtain an image data set which is assigned to the image captured by means of this optical device.

The image data set generated by the common electronic controller can also be assigned to an overall image which was captured by at least two of the optical devices. In this case, for example, the common electronic controller can be set up to create initially separate image data sets assigned to the corresponding optical devices in order to create therefrom the image data set assigned to the overall image, for example by merging the image data sets assigned to the corresponding optical devices, said image data sets then being assigned to sub-images of the overall image. It may however also be provided that the image data set assigned to the overall image is generated directly from the signals read from the corresponding image sensors.

It may be provided that by means of the common electronic controller optionally one of the optical devices is actuated and the corresponding image sensor is read, i.e. that the common electronic controller is set up optionally to actuate one of the optical devices and to read the corresponding image sensor.

It may however also be provided that by means of the common electronic controller at least two of the optical devices are actuated simultaneously, i.e. that the electronic controller can be set up to actuate at least two of the optical devices simultaneously so that these two optical devices can capture their images simultaneously. This is particularly advantageous if the image data set assigned to the overall image is to be generated.

The inventive household refrigeration appliance comprises the heat-insulated carcass with the inner container which delimits the coolable interior space. This is cooled by means of the refrigeration device. This refrigeration device is preferably configured as a refrigerant circuit essentially known to the person skilled in the art and is preferably designed in such a way that it cools the coolable interior space at least approximately to a predetermined temperature. The coolable interior space is provided for storing food.

The inventive household refrigeration appliance can comprise a heat-insulated door leaf which closes the coolable interior space in the closed state and makes this accessible in the open state.

The inventive household refrigeration appliance can for example be a household refrigerator. In this case the coolable interior space is cooled to temperatures greater than 0° C. The inventive household refrigeration appliance can however also be a combined fridge-freezer. The inventive household refrigeration appliance can have precisely one coolable interior space but also a plurality of coolable interior spaces, each of which can also be closed and opened by means of a door leaf.

The inventive household refrigeration appliance also comprises the inventive digital camera with which it is possible for example to produce an image of the interior of the household refrigeration appliance. The space required for the digital camera can be reduced as a plurality of optical devices can be actuated by a common electronic controller.

In this way several optics or optical devices are managed by precisely one electronic controller, for example a signal processor.

In particular in order to enlarge the possible acquisition region without having to implement too much unnecessary computing power in the system, a plurality of optical devices is actuated and evaluated by the electronic controller.

The electronic controller and the optical devices can preferably be arranged spatially separately from one another either in or on the household refrigeration appliance. It is then in particular provided that the electronic controller is set up to actuate the optical devices and to read the image sensors by means of communication routes.

In the case of a digital camera the electronic controller is normally larger, in particular significantly larger than its optical device. As however according to this variant of the inventive household refrigeration appliance the optical devices are attached in or to the household refrigeration appliance spatially separately from the electronic controller, the components provided for the image capture, i.e. the optical devices, can be attached more easily and/or more flexibly in or to the household refrigeration appliance.

A further advantage of the spatially separate arrangement of the optical devices from the electronic controller can be a reduction in the visible camera size as, for example, the relatively large electronic controller can be attached more flexibly in or to the household refrigeration appliance. As a result it is possible for example for the digital camera to be less obtrusive, for no relatively large holders to be required, for the integration options of the electronic controller to be enhanced in that for example said electronic controller is attached in a reinforcement part for example within a heat-insulated wall of the household refrigeration appliance.

The household refrigeration appliance comprises in particular a heat-insulated wall. The heat-insulated wall is for example a part of the heat-insulated carcass or is a heat-insulated door leaf.

The heat-insulated wall comprises in particular an inner membrane facing toward the coolable interior space and an outer membrane facing away from the coolable interior space. A heat insulation, which is embodied in particular as insulating foam, is arranged between the inner membrane and the outer membrane. In the case of the carcass the inner membrane is formed by the inner container. In the case of the door leaf the inner membrane in particular is formed by the side facing toward the coolable interior space.

According to one embodiment of the inventive household refrigeration appliance the electronic controller is attached within the heat-insulated wall, in particular within the heat-insulated door leaf or within the heat-insulated carcass. The electronic controller can be attached for example by means of a reinforcement part for example within the heat-insulated wall. The electronic controller is preferably arranged within the heat insulation, in the case of the insulation foam preferably embedded within this.

The communication routes can for example comprise as appropriate an LVDS (Low Voltage Differential Signaling) or a MIPI (Mobile Industry Processor Interface Alliance).

The communication routes can for example be wireless communication routes, e.g. WLAN or bluetooth communication routes.

The communication routes can however also be configured as wired options.

The communication routes are preferably configured as flexible printed circuits or comprise a flexible printed circuit. A flexible printed circuit (FPC) is a printed electronic circuit or printed conductor paths on a flexible carrier. The carrier is made for example from polyimide or is a polyester film and is coated in particular with a thin copper layer.

At least one of the optical devices can be attached in or to the carcass. In this way it is possible for the image data set to be assigned to the image of the side of the door leaf facing toward the coolable interior space.

At least one of the optical devices can also be attached in or to the door leaf so that the image data set is assigned for example to an image of the coolable interior space. In this context this at least one optical device can be attached directly in or to the door leaf or can be attached in or to the door rack attached to the side of the door leaf facing toward the coolable interior space or can be integrated into said door rack.

The household refrigeration appliance can also have a drawer which is arranged within the coolable interior space and which can be removed at least partially from the coolable interior space when the door leaf is open. In this case it can be provided that at least one of the optical devices is attached in or to this drawer. In this case it is preferably provided that the electronic controller actuates this optical device in such a way that the image is generated as the drawer is closed. To this end the household refrigeration appliance comprises for example a corresponding detection device which is connected to the electronic controller.

According to a preferred embodiment of the inventive household refrigeration appliance at least two of the optical devices are attached one above the other and/or adjacent to one another in or to the household refrigeration appliance. In this case the electronic controller is preferably set up to actuate at least these two optical devices simultaneously so that these two optical devices capture their images simultaneously and in particular the image data set is assigned to an overall image assigned to these images. In this way an image data set assigned to the overall image can be generated relatively easily in the case of a relatively wide and/or high household refrigeration appliance.

If for example the heat-insulated carcass of the household refrigeration appliance is relatively high or wide and an overall image of the coolable interior space is to be generated, then it can be provided that at least two of the optical devices are attached one above the other and/or adjacent to one another in or to the door leaf. The electronic controller is then preferably set up to actuate at least these two optical devices simultaneously so that these optical devices capture their image simultaneously of subareas of the coolable interior space and in particular the image data set is assigned to an overall image of the coolable interior space assigned to these images.

If for example the door leaf of the household refrigeration appliance is relatively high or wide and an overall image of the side of the door leaf facing toward the coolable interior space is to be generated, then it can be provided that at least two of the optical devices are attached one above the other and/or adjacent to one another in or to the carcass. The electronic controller is then preferably set up to actuate at least these two optical devices simultaneously so that these optical devices capture their image simultaneously of subareas of the side of the door leaf facing toward the coolable interior space and in particular the image data set is assigned to an overall image of the side of the door leaf facing toward the coolable interior space assigned to these images.

The inventive household refrigeration appliance can have a left door leaf and a right door leaf, each of which is mounted in relation to vertically running axes rotatably in relation to the carcass, wherein the left door leaf in the closed state closes a left subarea of the coolable interior space and makes this accessible in the open state, and the right door leaf in the closed state closes a right subarea of the coolable interior space and makes this accessible in the open state. In this case it can be provided that a first optical device or a first group of optical devices is attached in or to the household refrigeration appliance, in particular to its carcass, in such a way that it is able to capture an image of the side of the left door leaf facing toward the coolable interior space, and a second optical device or a second group of optical devices is attached in or to the household refrigeration appliance, in particular to its carcass, in such a way that it is able to capture an image of the side of the right door leaf facing toward the coolable interior space. For capturing the door leaves for example two optical devices arranged adjacent to one another in the case of so-called French-door appliances are therefore responsible for the door image. The left or right door image is captured per optical device or group of optical devices.

Exemplary embodiments of the invention are shown for illustration in the attached schematic drawings, in which:

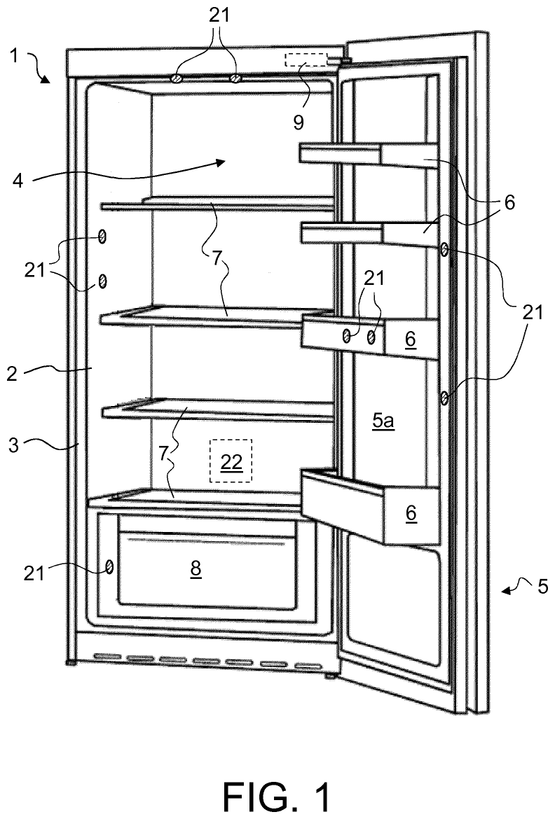

FIG. 1 shows a perspective representation of a household refrigeration appliance with a door leaf and at least one digital camera,

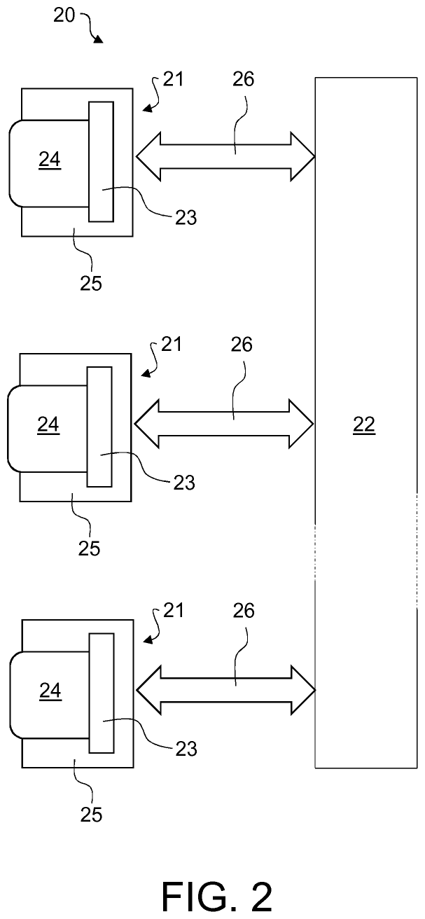

FIG. 2 shows the digital camera, and

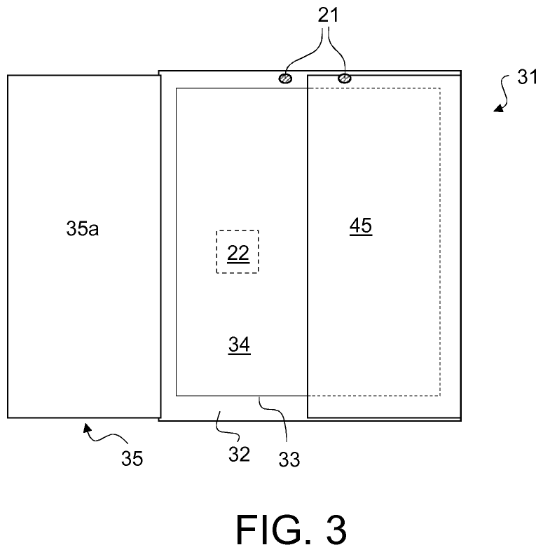

FIG. 3 shows a further household refrigeration appliance.

FIG. 1 shows, in a perspective view, a household refrigeration appliance 1 which comprises a heat-insulated carcass 2 with an inner container 3 which delimits a coolable interior space 4. The coolable interior space 4 is provided for storing food (not shown).

The household refrigeration appliance 1 further comprises a heat-insulated door leaf 5 which is mounted on the carcass 2, in particular rotatably in relation to a vertically running axis. In the event of an open door leaf 5 the coolable interior space 4 is accessible and in the event of a closed door leaf 5 the coolable interior space 4 is closed.

Arranged on the side 5a of the door leaf 5 facing in the direction of the coolable interior space 4 in the case of the present exemplary embodiment is a plurality of door racks 6 for storing food. Arranged in the coolable interior space 4 is in particular a plurality of shelves 7 for storing food and arranged in the lower region of the coolable interior space 4 is in particular a drawer 8 in which food can likewise be stored. Arranged above the drawer 8 is one of the shelves 7 which covers the upwardly directed opening of the drawer 8. In the case of an open door leaf 5 the drawer can be at least partially removed from the coolable interior space 4.

The household refrigeration appliance 1 comprises a refrigeration device (not shown in further detail) essentially known to the person skilled in the art preferably in the form of a refrigerant circuit for cooling the coolable interior space 4. The refrigerant circuit comprises for example a compressor, a condenser connected downstream of the compressor, a throttle device which is configured, in particular, as a throttle pipe or capillary pipe connected downstream of the condenser, and an evaporator which is arranged between the throttle device and the compressor.

In the case of the present exemplary embodiment, the household refrigeration appliance 1 comprises a controller (not shown in further detail) which is set up to actuate the refrigeration device, in particular the compressor of the refrigerant circuit in a manner that is commonly known to persons skilled in the art, such that the coolable interior space 4 has at least approximately a predetermined or predeterminable target temperature. The controller is preferably set up such that it regulates the temperature of the coolable interior space 4. In order, if required, to obtain the actual temperature of the coolable interior space 4, the household refrigeration appliance 1 can have at least one temperature sensor (not shown in further detail) which is connected to the controller.

In the case of the present exemplary embodiment, the household refrigeration appliance 1 comprises a digital camera 20, shown in FIG. 2, which is in particular set up to generate images or image data sets of the coolable interior space 4 or of the side 5a of the door leaf 5 facing toward the coolable interior space 4 assigned to the images.

The household refrigeration appliance 1 comprises in particular a heat-insulated wall. The heat-insulated wall is for example a part of the heat-insulated carcass 2 or is a heat-insulated door leaf 5.

The heat-insulated wall comprises in particular an inner membrane facing toward the coolable interior space 4 and an outer membrane facing away from the coolable interior space 4. Arranged between the inner membrane and the outer membrane is a heat insulation essentially known to a person skilled in the art in particular in the form of an insulation foam. In the case of the carcass 2 the inner membrane is formed by the inner container 3 and in the case of the door leaf 5 by the side 5a of the door leaf 5 facing toward the coolable interior space 4.

The digital camera 20 comprises a plurality of optical devices 21 and a common electronic controller 22. The optical devices 21 each comprise an image sensor 23 and a lens 24 arranged upstream of the image sensor 23. In the case of the present exemplary embodiment the image sensor 23 and the lens 24 are arranged within a casing 25.

The digital camera 20 or the household refrigeration appliance 1 further comprises communication routes 26 via which the electronic controller 22 is able to communicate with the optical devices 21. The electronic controller 22 is set up to actuate the optical devices 21 and to read the image sensors 23 by means of the communication routes 26 in order to generate at least one image data set from the signals read from the image sensors 23.

The electronic controller 22 comprises for example a circuit board (not shown in further detail) and electronics arranged on the circuit board, which are arranged for example within a further casing (not shown). The electronics comprise for example a microprocessor or a microcontroller.

In the case of the present exemplary embodiment the household refrigeration appliance 1 is configured in such a way that the digital camera 20 generates its images/image data set in the case of a closing door leaf 5 at a predetermined opening angle of, for example, 45°.

In order to detect the opening state of the door leaf 5, the household refrigeration appliance 1 comprises in the case of the present exemplary embodiment a corresponding detection device 9 which in the case of the present exemplary embodiment is configured in such a way that it detects the specific opening angle of the door leaf 5 of, for example, 45° and also detects when the door leaf 5 is closed. The detection device 9 is in particular connected to the electronic controller 22.

The electronic controller 22 and the optical devices 21 are attached spatially separately from one another and each in or to the household refrigeration appliance 1.

In the case of the present exemplary embodiment at least one of the optical devices 21 is attached in or to the carcass 2. In this way it is possible for an image data set assigned to this optical device or these optical devices 21 to be assigned to the image of the side of the door leaf 5 facing toward the coolable interior space 4.

In the case of the present exemplary embodiment at least one of the optical devices 21 is attached in or to the door leaf 5, in particular in or to one of the door racks 6 or integrated into said door racks so that an image data set assigned to this optical device or these optical devices 21 is assigned to the image of the coolable interior space 4.

It can also be provided that one of the optical devices 21 is attached in or to the drawer 8. In this case it is preferably provided that the electronic controller 22 actuates this optical device 21 in such a way that the image is generated as the drawer 8 is closed. To this end the household refrigeration appliance 1 comprises for example a corresponding detection device (not shown in further detail) which is connected to the electronic controller 22.

In the case of the present exemplary embodiment the electronic controller 22 is attached within the heat-insulated wall, for example within the heat-insulated door leaf 5 or within the heat-insulated carcass 2. The electronic controller 22 can be attached for example by means of a reinforcement part (not shown in further detail) for example within the heat-insulated wall. The electronic controller 22 can be embedded into the insulating foam.

In order for the electronic controller 22 to be able to communicate with the spatially separate optical device 21 attached in or to the household refrigeration appliance 1, the digital camera 20 or the household refrigeration appliance 1 comprises the communication routes 26.

The communication routes 26 can comprise for example LVDS or MIPI interfaces.

The communication routes 26 can for example be wireless communication routes, e.g. WLAN or Bluetooth communication routes.

In the case of the present exemplary embodiment the communication routes 26 are configured as wired options.

In the case of the present exemplary embodiment the communication routes 26 are configured as flexible circuits or comprise a flexible circuit.

In the case of the present exemplary embodiment four optical devices 21 are arranged in or on the carcass 2, in particular two adjacent to one another and two one above the other. The electronic controller 22 is set up to actuate these four optical devices 21 simultaneously in the case of a closing door leaf 5 at the predetermined opening angle so that in the case of the present exemplary embodiment these four optical devices 21 capture their images simultaneously. The electronic controller 22 then reads the image sensors 23 of these four optical devices 21 and generates an image data set which is assigned to an image or overall image of the side 5a of the door leaf 5 assigned to the interior space 4. In this case, for example, the electronic controller 22 can be set up to create initially a plurality of image data sets assigned to the corresponding optical devices 21 in order to create therefrom the image data set assigned to the overall image, for example by merging the image data sets assigned to the corresponding optical devices 21 which are then assigned to sub-images of the overall image. It may however also be provided that the image data set assigned to the overall image is generated directly from the signals read from the corresponding image sensors 23.

In the case of the present exemplary embodiment four further optical devices 21 are arranged in or on the door leaf 5, in particular two adjacent to one another and two one above the other. The optical devices 21 arranged adjacent to one another are in particular integrated into one of the door racks 6 and the optical devices 21 arranged one above the other are in particular arranged directly in or on the door leaf 5. The electronic controller 22 is set up to actuate these four optical devices 21 simultaneously in the case of a closing door leaf 5 at the predetermined opening angle so that in the case of the present exemplary embodiment these four optical devices 21 capture their images simultaneously. The electronic controller 22 then reads the image sensors 23 of these four optical devices 21 and generates an image data set which is assigned to an image or overall image of the coolable interior space 4. In this case, for example, the electronic controller 22 can be set up to create initially a plurality of image data sets assigned to the corresponding optical devices 21 in order to create therefrom the image data set assigned to the overall image, for example by merging the image data sets assigned to the corresponding optical devices 21 which are then assigned to sub-images of the overall image. It may however also be provided that the image data set assigned to the overall image is generated directly from the signals read from the corresponding image sensors 23.

FIG. 3 shows a further household refrigeration appliance 31 which comprises a heat-insulated carcass 32 with an inner container 33 which delimits a coolable interior space 34. The coolable interior space 44 is provided for storing food (not shown).

The household refrigeration appliance 31 shown in FIG. 3 distinguishes itself mainly from the household refrigeration appliance 1 shown in FIG. 1 in that it has a left door leaf 35 and a right door leaf 45 which are each mounted in relation to vertically running axes rotatably in relation to the carcass 32.

The left door leaf 35 closes in the closed state a left subarea of the coolable interior space 34 and makes this accessible in the open state. In FIG. 3 the left door leaf 35 is shown in the open state.

The right door leaf 45 closes in the closed state a right subarea of the coolable interior space 34 and makes this accessible in the open state. In FIG. 3 the right door leaf is shown in the closed state.

The household refrigeration appliance 31 also comprises the digital camera 20.

In the case of the present exemplary embodiment it is provided that one of the optical devices 21 arranged in or on the carcass 32 is actuated by the common electronic controller 22 in the case of a closing left door leaf 35 and the predetermined opening angle such that this optical device 21 captures an image of the side 35a of the left door leaf 35 facing toward the coolable interior space 32, and the common electronic controller 22 reads the image sensor 23 of this optical device 21 to generate an image data set which is assigned to the image of the left door leaf 35. A plurality of optical devices 21 arranged in or on the carcass 32 can also be assigned to the left door leaf 35.

In the case of the present exemplary embodiment it is also provided that one of the optical devices 21 arranged in or on the carcass 32 is actuated by the common electronic controller 21 in the case of a closing right door leaf 44 and the predetermined opening angle such that this optical device 21 captures an image of the side of the right door leaf 45 facing toward the coolable interior space 32, and the common electronic controller 22 reads the image sensor 23 of this optical device 21 to generate an image data set which is assigned to the image of the right door leaf 45. A plurality of optical devices 21 arranged in or on the carcass 32 can also be assigned to the right door leaf 45.

### LIST OF REFERENCE CHARACTERS

1 Household refrigeration appliance
2 Carcass
3 Inner container
4 Coolable interior space
5 Door leaf
5a Side
6 Door rack
7 Shelves
8 Drawer
9 Detection device
20 Digital camera
21 Optical device
22 Electronic controller
23 Image sensor
24 Lens
25 Casing
26 Communication route
31 Household refrigeration appliance
32 Carcass
33 Inner container
34 Coolable interior space
35 Left door leaf
35a Side
45 Right door leaf

1-12. (canceled)

13. A digital camera, comprising:
at least two optical devices each including an image sensor and a lens arranged upstream of said image sensor; and
a common electronic controller configured to actuate said at least two optical devices and to read said image sensors in order to generate at least one image data set based on a reading of said image sensors.

14. The digital camera according to claim 13, wherein the image data set is assigned to an image which was captured by precisely one of said at least two optical devices, and/or the image data set is assigned to an overall image which was captured by at least two of said at least two optical devices.

15. The digital camera according to claim 13, wherein said common electronic controller is configured to actuate at least two of said optical devices simultaneously in order for said two optical devices to capture respective images simultaneously, and/or said common electronic controller is configured optionally to actuate one of said optical devices.

16. A household refrigeration appliance, comprising:
a heat-insulated body with an inner container, which delimits a coolable interior space provided for storing food, and a refrigeration device for cooling the coolable interior space; and
a digital camera mounted in or on said heat-insulated body, said digital camera having at least two optical devices each including an image sensor and a lens arranged upstream of said image sensor, and a common electronic controller configured to actuate said at least two optical devices and to read said image sensors in order to generate at least one image data set based on a reading of said image sensors.

17. The household refrigeration appliance according to claim 16, wherein said electronic controller and the optical devices are arranged spatially separate from one another either in or on said heat-insulated body, and said common electronic controller is configured to actuate said optical devices and to read said image sensors by way of respective communication routes.

18. The household refrigeration appliance according to claim 16, wherein at least two of said optical devices are attached one above another and/or adjacent one another in or to said heat-insulated body, and said common electronic controller is configured to actuate at least said two optical devices simultaneously so that said two optical devices capture their images simultaneously.

19. The household refrigeration appliance according to claim 18, wherein said two optical devices are actuated simultaneously and the image data set is assigned to an overall image assigned to these images.

20. The household refrigeration appliance according to claim 16, wherein:
said heat-insulated body includes a heat-insulated door leaf configured to close the coolable interior space in a closed state and to render the coolable interior space accessible in an open state; and
at least two of said optical devices are attached one above another and/or adjacent one another in or to said door leaf, and said common electronic controller is configured to actuate two optical devices simultaneously so as to cause said two optical devices to simultaneously capture respective images of subareas of the coolable interior space and the image data set is assigned to an overall image of the coolable interior space assigned to these images; and/or
at least two of said optical devices are attached one above another and/or adjacent one another in or to said heat-insulated body facing toward said door leaf, and said common electronic controller is configured to actuate at least said two optical devices simultaneously so as to cause said two optical devices to simultaneously capture respective images of subareas of a side of said door leaf facing toward the coolable interior space and in particular the image data set is assigned to an overall image of the side of said door leaf facing toward the coolable interior space assigned to these images.

21. The household refrigeration appliance according to claim 16, wherein:
said heat-insulated body includes a left door leaf and a right door leaf, each rotatably mounted about a vertically running axis;
said left door leaf in a closed state closes a left subarea of the coolable interior space and renders the left subarea accessible in an open state, and said right door leaf in a closed state closes a right subarea of the coolable interior space and renders the right subarea accessible in an open state;
a first optical device or a first group of optical devices is attached in or to said heat-insulated body and is configured to capture an image of a side of said left door leaf facing toward the coolable interior space; and
a second optical device or a second group of optical devices is attached in or to said heat-insulated body and is configured to capture an image of the side of said right door leaf facing toward the coolable interior space.

22. The household refrigeration appliance according to claim 21, wherein said first optical device or said first group of optical devices is disposed to face toward said left door leaf and said second optical device or said second group of optical devices is disposed to face toward said right door leaf.

23. A method of generating an image set, the method comprising:
providing a digital camera with at least two optical devices each including an image sensor and a lens arranged upstream of the image sensor, and a common electronic controller configured to actuate the at least two optical devices and to read the image sensors;
actuating at least one of the optical devices with the electronic controller;
reading the corresponding image sensors by the common electronic controller; and
generating with the electronic controller at least one image data set on a basis of the reading of the at least one image sensor.

24. The method according to claim 23, which comprises simultaneously actuating at least two of the optical devices by the common electronic controller to simultaneously capture images with the at least two optical devices, and generating with the common electronic controller an image data set which is assigned to an overall image assigned to these images.

25. A method of operating a household refrigeration appliance, the method comprising:
providing a household refrigeration appliance according to claim 16;
actuating at least one of the optical devices by the common electronic controller;
reading the corresponding image sensor by by the common electronic controller; and
generating at least one image data set on a basis of the read image sensor by the common electronic controller.

26. The method according to claim 25, which comprises simultaneously actuating at least two of the optical devices by the common electronic controller so as to cause the two optical devices to capture their images simultaneously, and generating with the common electronic controller an image data set which is assigned to an overall image assigned to these images.
